(19) United States
(12) Patent Application Publication
(10) Pub. No.: US 2015/0003622 A1
(43) Pub. Date: Jan. 1, 2015

(54) HEADPHONE CABLE AND PLUG THEREOF

(71) Applicant: Powertech Industrial Co., Ltd., New Taipei City (TW)

(72) Inventors: YU-LUNG LEE, NEW TAIPEI CITY (TW); CHUN-CHUAN CHEN, NEW TAIPEI CITY (TW)

(73) Assignee: Powertech Industrial Co., Ltd., New Taipei City (TW)

(21) Appl. No.: 14/074,777

(22) Filed: Nov. 8, 2013

(30) Foreign Application Priority Data
Jun. 28, 2013 (TW) 102123256

(51) Int. Cl. H04R 1/10; H04R 3/00

(52) U.S. Cl. CPC H04R 1/1033; H04R 3/002
USPC 381/71.6

(57) ABSTRACT

A headphone cable and a plug thereof are provided. The headphone cable includes a first plug, a first microphone module, a first transmission line, a noise-cancellation module, and a second transmission line. The first plug has a first isolation portion with a first connector protruded thereon. The first connector is for plugging into a first headphone jack of a headphone. The first microphone module is disposed on the first isolation portion. The first transmission line has one end thereof connected to the first plug and the other end thereof connected to the noise-cancellation module. The second transmission line is connected to the noise-cancellation module and a playback apparatus. The noise-cancellation module generates a noise-cancellation signal to be combined with an audio signal being outputted to the headphone responsive to an environmental noise received through the first microphone module.

### BACKGROUND

1. Technical Field

The present disclosure relates to a cable and a plug thereof in particular, to a headphone cable having noise-cancellation capability and a plug thereof.

2. Description of Related Art

Nowadays, headphones have been widely used for listening to audio sources anywhere and anytime without disturbing others. However, in daily usage headphone users generally are unable to listen to music with clear sounds quietly and relaxedly due to intensive interference from the surrounding noises, such as the operational noises from air conditioners, automobiles or motorcycles, or even crowd noises. To increase the headphone sound quality and performance, industries recently have come up with active noise-cancellation headphones, known as the ANC headphones, which can reduce or eliminate the impact of environmental noise on the sound quality of the headphones using active noise-cancellation technique. Specifically, an ANC headphone has a microphone disposed thereon for capturing background noises sensed by the ANC headphone and correspondingly generating a noise-cancellation signal to a sound generation circuit of the ANC headphone, so as to eliminate the surrounding noises.

However, under the current ANC headphone structure, the noise-cancellation circuit and the battery are connected and integrated inside the ANC headphone, which not only would increase the design complexity and associated manufacturing cost of the headphones, placing limitation on the physical size of headphones, at same time also increase the sale price of the headphone.

### SUMMARY

Accordingly, the present disclosure provides a headphone cable and a plug thereof, which can through disposing a microphone component for sensing environmental noises on the plug of the headphone simplify the headphone circuit design and the associated manufacturing cost while attaining the objective of mitigating the effects of environmental noises using the active noise-cancellation technique.

An exemplary embodiment of the present disclosure provides a headphone cable, which is adapted for connecting a headphone to a playback apparatus. The headphone cable includes of a first plug, a first microphone module, a first transmission line, a noise-cancellation module, and a second transmission line. The first plug has a first isolation portion with a first connector protruded thereon. The first connector is adapted for plugging into a first headphone jack of the headphone. The first microphone module is disposed on the first isolation portion. The first transmission line has one end thereof electrically connected to the first plug. The noise-cancellation module is electrically connected to the other end of the first transmission line. The second transmission line is configured for electrically connecting the noise-cancellation module to the playback apparatus. The noise-cancellation module correspondingly generates a noise-cancellation signal to be combined with an audio signal being outputted to the headphone in responsive to an environmental noise received through the first microphone module.

Another exemplary embodiment of the present disclosure provides a headphone cable, which is adapted for connecting a headphone to a playback apparatus. The headphone cable includes a first plug, a first microphone module, a first transmission line, and a headphone adapter. The first plug has a first isolation portion with a first connector protruded thereon. The first connector is adapted for plugging into a first headphone jack of the headphone. The first microphone module is disposed on the first isolation portion. The first microphone module operatively generates a noise signal upon receiving an environmental noise. The first transmission line has one end thereof electrically connected to the first plug. The headphone adapter has a Bluetooth transmission module and a noise-cancellation module. The Bluetooth transmission module can wirelessly connect to the playback apparatus. The noise-cancellation module is electrically connected to the other end of the transmission line. The noise-cancellation module correspondingly generates a noise-cancellation signal to be combined with an audio signal being outputted to the headphone in responsive to an environmental noise received through the first microphone module.

An exemplary embodiment of the present disclosure provides a plug of headphone, which adapted for connecting to a headphone. The plug comprises an isolation portion, a connector, and a microphone module. The connector is protruded on the isolation portion. The connector is adapted to plug into a headphone jack of the headphone. The microphone module is disposed on the isolation portion.

To sum up, the present disclosure provides a headphone cable and a plug thereof, which can through respectively disposing the microphone component and noise-cancellation circuit on the plug and the headphone cable actively eliminate the environmental noises sensed by a headphone using the noise sensing-feedback mechanism, while simplify the headphone circuitry, thereby enhances the sound quality of the headphone.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1A is a diagram of a headphone cable provided by a first exemplary embodiment of the present disclosure.

FIG. 1B is another diagram of a headphone cable provided by the first exemplary embodiment of the present disclosure.

FIG. 2A is a cross-sectional diagram of a headphone cable provided in accordance to the first exemplary embodiment of the present disclosure.

FIG. 2B is a diagram of a headphone cable provided in accordance to the first exemplary embodiment of the present disclosure.

FIG. 3 is a diagram of a headphone cable having dual plug provided in accordance to the first exemplary embodiment of the present disclosure.

FIG. 4 is a diagram of a headphone cable provided in accordance to a second exemplary embodiment of the present disclosure.

FIG. 5 is a diagram of a headphone cable provided in accordance to a third exemplary embodiment of the present disclosure.

FIG. 6 is a diagram of a headphone cable provided in accordance to a fourth exemplary embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

The present disclosure provides a headphone cable, which can integrate the noise-cancellation circuit and at least a sound receptor component for sensing noise thereon and achieve the objective of eliminating environmental noise while simplify the internal circuitry of the headphone. The design of headphone cable can be applied to a standard three-terminal jack, standard four-terminal jack or a five-terminal jack.

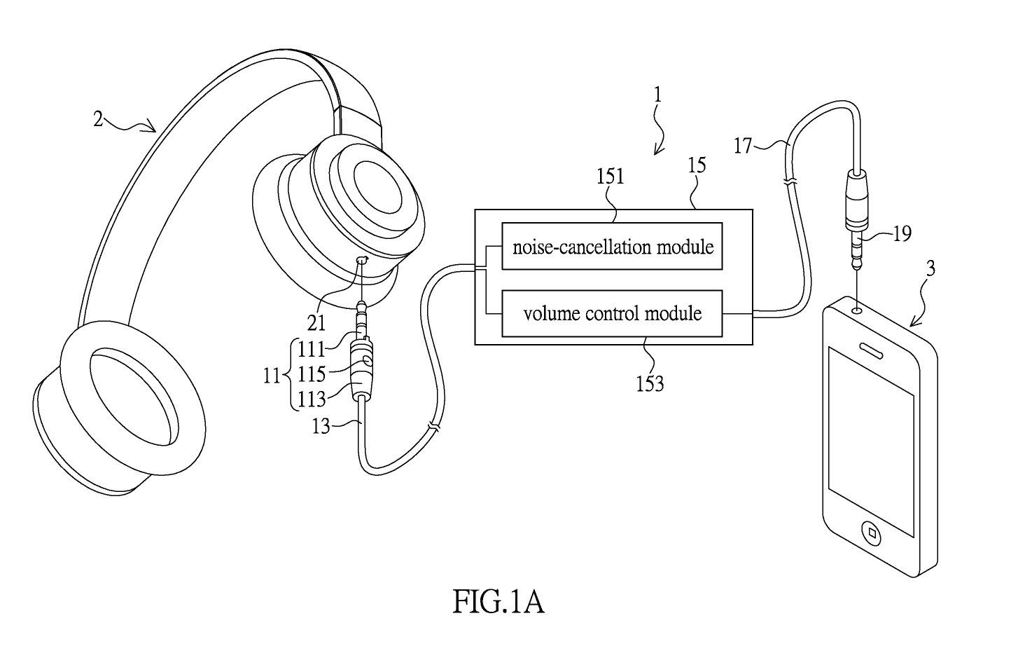

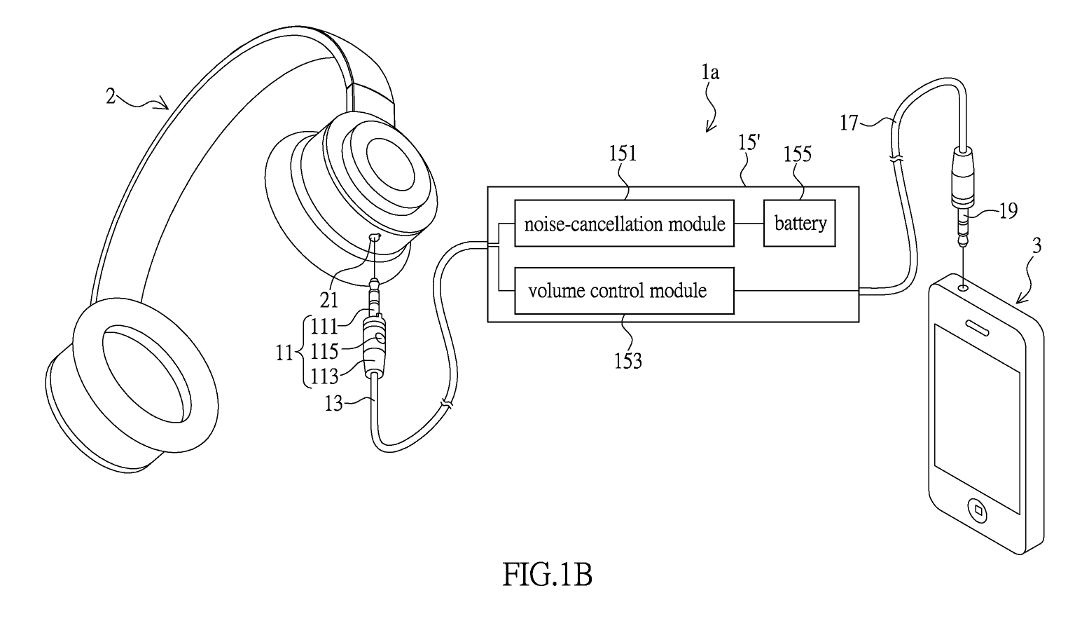

Please refer to FIG. 1A, which shows a diagram illustrating a headphone cable provided in accordance to a first exemplary embodiment of the present disclosure. The headphone cable 1 is adapted for connecting a headphone 2 to a playback apparatus 3. The headphone cable 1 is configured for electrically connecting the headphone 2 and the playback apparatus 3 and delivering the audio signal outputted by the playback apparatus 3 to the headphone 1 for audio playback operations. The playback apparatus 3 may be an electronic device including but not limited to a mobile phone, a tablet, a personal digital assistance (PDA), a laptop, a camcorder and a MP3 player.

The headphone cable 1 includes a first plug 11, a first transmission line 13, a headphone adapter 15, a second transmission line 17, and a plug 19. The first plug 11 is electrically connected to a first end of the first transmission line 13. A second end of the first transmission line 13 is electrically connected to the headphone adapter 15. The headphone adapter 15 is electrically connected to a first end of the second transmission line 17. A second end of the second transmission line 17 is electrically connected to a plug 19.

The first plug 11 includes a first connector 111, a first isolation portion 113, and a first microphone module 115. The first connector 111 is adapted for plug into a first headphone jack 21 of the headphone 2. The first connector 111 is further electrically connected to the first end of the first transmission line 13 through the first isolation portion. The plug 19 is adapted for plugging into a corresponding audio jack on the playback apparatus 3.

The first connector 111 is protruded on one end of the first isolation portion. In the instant embodiment, the first connector 111 is a three-terminal plug structure, i.e., a standard headphone cable structure. The first connector 111 has a left audio channel, a right audio channel, and a ground. The first connector 111 may be also designed to be a four-terminal or five terminal plug structure according to the actual product needs.

The first microphone module 115 is disposed on the first isolation portion 113. The first microphone module is used for operatively generating a noise signal upon receiving the environmental noises being sensed by the headphone 2. The first microphone module 115 is used for sampling the environmental noises external to the headphone 2 to generate the noise signal, wherein the noise signal is processed by a noise-cancellation circuit for further analysis. The environmental noises are the non-playback apparatus 3 outputted audio signals, wherein the audio signal described herein refers to the lower or mid frequency signal ranging between 100 Hz to 1000 Hz. The environmental noises may include but not limited to the operational noises of air conditioners, transportation vehicles, factory equipment operation noise, noise of crowd and any other unwanted audio signals affecting the sound quality of the headphone.

The placement of the first microphone module 115 on the first isolation portion 113 may be configured according to the distance required between the first microphone module 115 and the first connector 111 when the first connector 111 is plugged into the first headphone jack 21 of the headphone 2. The first microphone module 115 may be one of condenser microphones, piezoelectric microphones, dynamic microphones, or Micro-Electrical-Mechanical System microphones. The exact structure of the first microphone module 115 may be designed according to the actual requirement of sound reception quality and the present disclosure is not limited thereto.

The headphone adapter 15 may further include a noise-cancellation module 151 and the volume control module 153. The noise-cancellation module 151 is electrically connected the second end of the first transmission line 13 to receive the noise signals outputted from the first microphone module 115 in responsive to the environmental noises. The volume control module 153 is electrically connected to the second end of the first transmission line 13 and the first end of the second transmission line 17 to receive the audio signal outputted by the playback apparatus 3.

The noise-cancellation module 151 is configured for generating a noise-cancellation signal according to the noise signal outputted by the first microphone module 115. Specifically, the noise-cancellation module 151 performs computation to the noise signal received and generates a noise-cancellation signal having substantially equal amplitude but 180 degree out of phase. The noise-cancellation module 151 outputs the noise-cancellation signal to be combined with (e.g., added onto) the audio signal) received by a speaker (e.g., a sound amplification section) of the headphone 2 through the first transmission line 13 to cancel out the noise signal. The noise-cancellation module 151 of the instant embodiment may be implemented by a noise-cancellation circuit.

The volume control module 153 is configured for adjusting the volume level of the speaker of headphone 2 associated with the audio signal. The volume control module 153 may output a volume control signal to the playback apparatus 3 responsive to a user adjustment (e.g., via a button) to correspondingly adjust the amplitude of the audio signal. In another embodiment, user may through a rolling operation cause the volume control module 153 to adjust the amplitude of the audio signal. Accordingly, the volume control module 153 may be implemented by a volume control circuit comprising of switching components and resistors or variable resistors.

The noise-cancellation technique of the noise-cancellation module 151 and the volume adjustment technique of the volume control module 153 are well known arts in the field and those skilled in the art should be able to deduce the operation method and associated circuitry structure of the noise-cancellation module 151 and the volume control module 153, thus further descriptions are hereby omitted.

The structure of the plug 19 in the instant embodiment is the same as the first connector i.e. take form of a three-terminal plug structure. The plug 19 can also have a left audio channel, a right audio channel, and a ground. The plug 19 can be used to deliver the volume control signal outputted by the volume control module 153 of the headphone adapter 15 to the playback apparatus 3 to correspondingly adjust the volume level of the speaker of headphone 2 associated with the audio signal. The plug 19 can further deliver the audio signals (e.g., left audio signal and right audio signal) outputted by the playback apparatus 3 to the headphone adapter 15.

The plug 19 not only can be configured for transmitting the audio signal outputted by the playback apparatus 3 to the headphone 2 through the second transmission line 17, the headphone adapter 15 and the first transmission line 13 for playback operation, but also at same time transmitting the volume control signal outputted by the volume control signal 153 of the headphone adapter 15 to the playback apparatus 3. In other embodiment, the plug 19 may be implemented by a USB plug. It shall be noted that the exact structure of the plug 19 may vary depend upon the exact structure of the playback apparatus 3.

The headphone adapter 15 may further include a battery, which is used for powering the noise-cancellation module 151. Please refer to FIG. 1B, which shows another diagram illustrating a headphone cable provided in accordance to the first exemplary embodiment of the present disclosure. The headphone cable 1a is electrically connected to the headphone 2 and the playback apparatus 3 and is configured to deliver the audio signal outputted playback apparatus 3 to the headphone 2 for playback operation. The headphone adapter 15′ of headphone cable 1a includes a noise-cancellation module 151, a volume control module 153, and a battery 155. The battery 155 is electrically connected to the noise-cancellation module 151 and providing the necessary power to power the operation of the noise-cancellation module 151. The battery 155 may be a dry battery such as No. 3 (Size AA) dry battery or No. 4 (Size AAA) dry battery or a rechargeable battery and the instant embodiment is not limited to the examples provided herein.

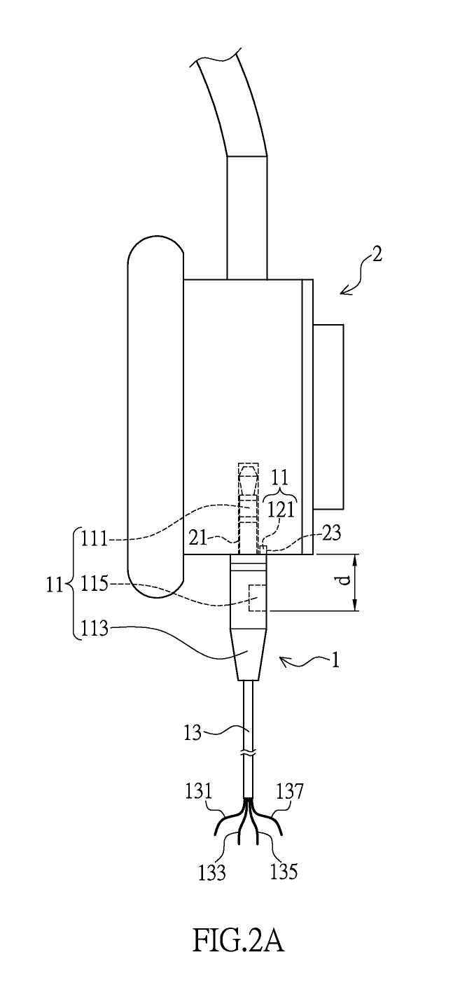

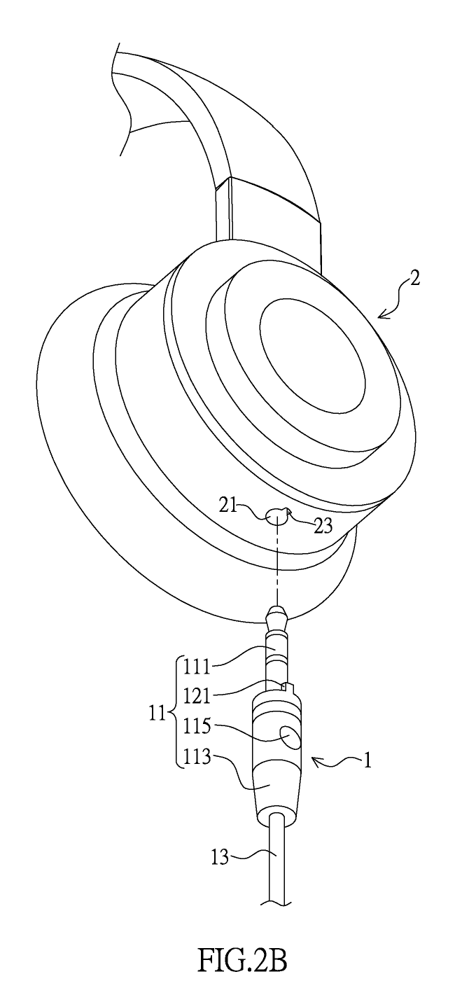

Please refer to FIG. 2A and FIG. 2B in conjunction with FIG. 1B. FIG. 2A shows a cross-sectional diagram of a headphone cable provided in accordance to the first exemplary embodiment of the present disclosure. FIG. 2B shows a diagram of a headphone cable provided in accordance to the first exemplary embodiment of the present disclosure.

As shown in FIG. 2A and FIG. 2B, the first connector 111 is protruded on the isolation portion 113. The first connector 111 is adapted for plugging into a first headphone jack 21 of the headphone 2. The distance between the first connector 111 and the first microphone 115 module is denoted as d and d is preferably configured to be less than 10 cm to precisely capture the environmental noises received or sensed by the headphone 2.

The first transmission line 13 includes a common ground wire 131, audio wires 133, 135, and a microphone wire 137. The common ground wire 131 is electrically connected to a ground of the playback apparatus 3. The audio wires 133 and 135 are electrically connected to the noise-cancellation module 51 and the first plug 11, respectively. The audio wires 133 and 134 are a left audio wire and a right audio wire, respectively. The audio wires 133 and 134 are configured for transmitting the audio signals to the headphone 2, respectively upon receiving the audio signals from the playback apparatus 3 through the headphone adapter 15′. The microphone wire 137 is electrically connected between the first microphone module 115 and the noise-cancellation module 151. The microphone wire 137 is configured for transmitting the noise signal outputted by the first microphone module 115 to the headphone adapter 15′. The microphone wire 137 can further transmit the noise-cancellation signal to be added onto the audio wires 133 and 135 so as to eliminate the environmental noises, wherein the noise cancellation signal is generated by the noise-cancellation module 151 in responsive to the noise signal received from the first microphone module 115.

Due to the fact that when the first connector 111 of the first plug 11 is plugged into the first headphone jack of the headphone 2, the first microphone module 115 might rotate toward the speaker direction of the headphone 2 during user operation and reduce the sensitivity of detecting external environmental noise. The present disclosure further provides a locking structure to avoid having the first microphone module 115 from being rotated toward the speaker direction of the headphone 2 during user operation.

The first isolation portion 113 has a first rotational angle limiting structure 121 while the first headphone jack 21 has a first connecting structure 23 corresponding to the first rotational angle limiting structure 121. The first rotational angle limiting structure 121 is arranged on the edge of the first isolation portion 113 and has substantially square-shaped structure. The first connecting structure 23 has a recess shaped in corresponding to the first rotational angle limiting structure, i.e., a square-shaped recess structure. The depth of the recess of the first connecting structure corresponds to the length of the first rotational angle limiting structure 121.

When the first connector 111 plugs into the first headphone jack 21, the first rotational angle limiting structure 121 connects the first connecting structure 23 to limit the rotational angle of the first microphone module 115 and causes the first microphone module 115 to face away from a speaker direction of the headphone 2. Specifically, when the position of the first connector 111 is locked when the first rotational angle limiting structure 121 connects the first connecting structure 23 to limit the degree of rotation of the first plug 11. Such that the first microphone module 115 can be configured to face away from the speaker direction of the headphone 2, i.e., the sound output direction of the headphone 2. Accordingly, the environmental noises can be accurately sensed and captured so that the impact of the environmental noises on the sound performance of the headphone 2 can be effectively eliminated.

The first headphone jack 21 may have one or more first connecting structures 23 so that the first rotational angle limiting structure 121 of the first plug 11 can connect to the first connecting structure 23 at various angles as needed thereby providing user convenience. The first plug 11 can be rotated to any angle so long as the first microphone module 115 does not face toward the speaker direction of the headphone 2. Accordingly, the first microphone module 115 on the first plug 11 can rotate along with the rotation of the first plug 11, and the maximum rotation angel is 180 degrees.

The shaped of the first connecting structure 23 can be configured to a semi-circular-shaped recess for limiting the rotating range of the first rotational angle limiting structure 121 so as to limit the rotational angle of the first microphone module 115. The exact placements and structures of the first rotational angle limiting structure 121 and the first connecting structure 23 are configured according to the exact facing direction of the first microphone module 115 required and the present disclosure is not limited thereto. FIG. 2A and FIG. 2B are merely used to illustrate an embodiments of the first rotational angle limiting structure 121 and the first connecting structure 23 and the present disclosure is not limited thereto.

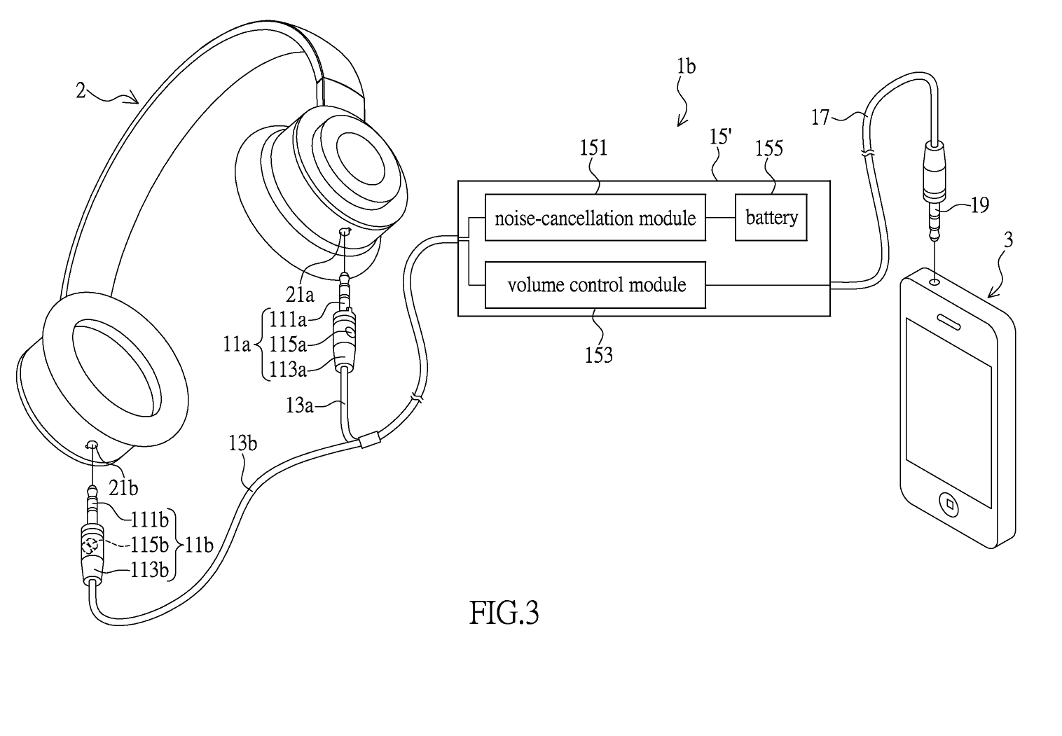

The structure of the headphone cable 1 may be also configured to have dual plug structure in corresponding to the structure of headphone 2. Please refer to FIG. 3, which shows another exemplary diagram illustrating a headphone cable having dual plug in accordance to the first exemplary embodiment of the present disclosure.

The headphone cable 1b includes a first plug 11a and a second plug 11b. The first plug 11a and the second plug 11b are connected to the noise-cancellation module 151 of the headphone adapter 15′ respectively through a first transmission line 13a and the third transmission line 13b. The first plug 11a includes a first connector 111a, a first isolation portion 113a, and a first microphone module 115a. The second plug 11b includes a second plug 111b, a second isolation portion 113b, and a second microphone module 115b. The first connector 11a is protruded on the first isolation portion 113a while the second connector 11b is protruded on the second isolation portion 113b. The first microphone module 115a and the second microphone module 115b are respectively disposed on the first isolation portion 113a and the second isolation portion 113b. The first microphone module 115a and the second microphone module 115b are respectively spaced a predetermined distance from the first connector 111a and the second connector 111b. The distance between the first microphone module 115a and the first connector 111a may be configured to be the same or different from the distance between the second microphone module 115b and the second connector 111b. In a preferable embodiment, both the distance between the first microphone module 115a and the first connector 111a and the distance between the first microphone module 115a and the first connector 111a shall be configured to be less than 10 cm.

The first connector 111a of the first plug 11a is adapted for plugging into a first headphone jack 21a of the headphone 2 while the second plug 11b of the second connector 111b of the second plug 11b is adapted for plugging into a second headphone jack 21b. The first plug 11a and the second plug 11b respectively transmit the audio signals (e.g., the left audio signal and the right audio signal) outputted by the playback apparatus 3 to the headphone 2 during the playback operation of the playback apparatus 3.

The first microphone module 115a and the second microphone module 115b are configured for respectively receiving the environmental noises from the left and the right side of the headphone 2 and correspondingly generating noise signals. The first microphone module 115a and the second microphone module 115b synchronously transmit the noise signals generated individually to the noise-cancellation module 151 of the headphone adapter 15′ to have the noise-cancellation module 151 correspondingly generating the noise-cancellation signals for left channel and the right channel. Subsequently, the noise-cancellation module 151 respectively transmits the noise-cancellation signals for the left channel and the right channel to the headphone 2 to combine the noise-cancellation signal for the left channel with the left audio signal and the noise-cancellation signal for the right channel with the right audio signal. Accordingly, the impact of the environmental noises on the sound performance of the headphone 2 may be mitigated or even eliminated.

The first isolation portion 113a of the first plug 11a has a first rotational angle limiting structure while the first headphone jack 21a has a first connecting structure corresponding to the first rotational angle limiting structure. Such that when the first connector 111a plugs into the first headphone jack 21a of the headphone 2, the first rotational angle limiting structure connects the first connecting structure for limiting the rotational angle of the first microphone module 115a and causes the first microphone module 115a to face away from a speaker direction (i.e., the left channel speaker direction) of the headphone 2.

The second isolation portion 113b of the second plug 11b has a second rotational angle limiting structure while a second headphone jack 21b of the headphone 2 has a second connecting structure corresponding to the second rotational angle limiting structure. Such that when the second connector plugs into the second headphone jack 21b, the second rotational angle limiting structure connects the second connecting structure for limiting the rotational angle of the second microphone module 115b and causes the second microphone module 115b to face away from a speaker direction (i.e., the right channel speaker direction) of the headphone 2. The headphone cable 1b may thus effectively eliminate the environment noises for the left and the right audio channels, and enhances the sound quality of the headphone 2. The rest of the structure of the headphone cable 1b is essentially the same as the headphone cable 1, and based on the above explanation those skilled in the art should be able to infer the structure and the operation of the headphone 1b and further description are hereby omitted.

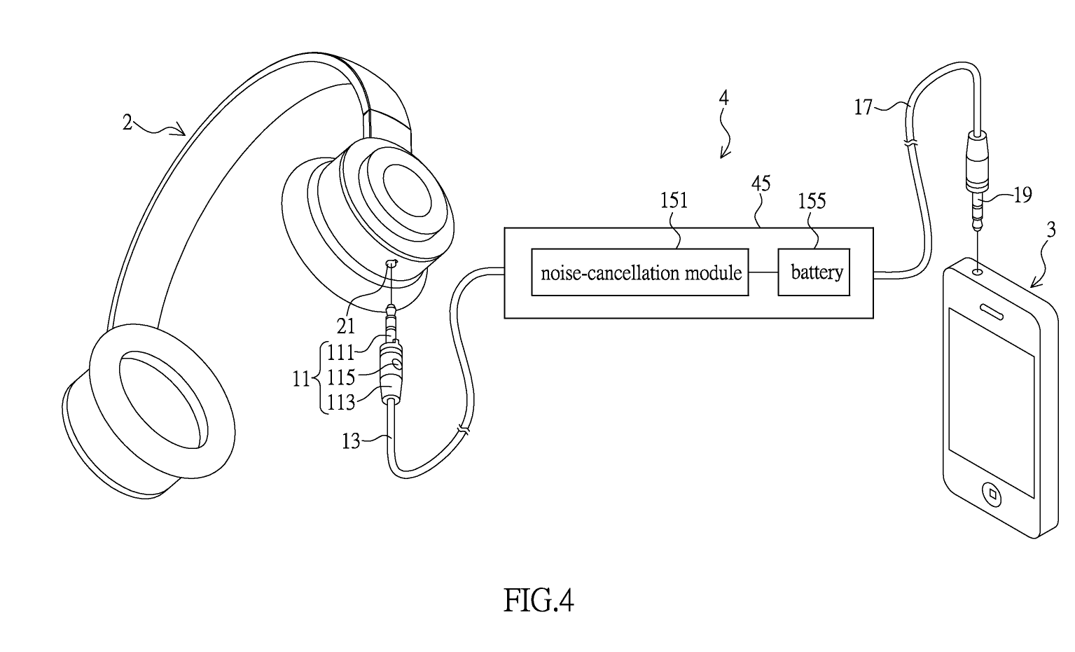

The noise-cancellation module and the volume control module described in the previous embodiment are integrated in the headphone adapter, however, in practice if the headphone cable doesn't have volume control capability, then the headphone adapter may only include the nose-cancellation circuit for the noise-cancellation module, and the headphone user may to control the volume using the playback apparatus. Please refer to FIG. 4, which shows a diagram illustrating a headphone cable provided in accordance with a second embodiment of the present disclosure.

The difference between the headphone cable 4 of FIG. 4 and the headphone cable 1 of FIG. 1 is in the structure of the headphone adapter 15. A headphone adapter 45 of the headphone cable 4 includes only a noise-cancellation module 151 and the battery 155. The noise-cancellation module 151 is electrically connected to the battery 155. The noise-cancellation module 151 is configured to process the noise signal outputted by the first microphone module 115 in responsive to the environmental noises and correspondingly generate the noise-cancellation signal to the audio signals received by headphone 2. The headphone adapter 45 is configured for combining (e.g., add onto) the audio signals received from the playback apparatus 3 and the noise-cancellation signal outputted by the noise-cancellation module 151 and outputting the combined signal to the speaker of the headphone 2 to eliminate the environmental noises received by the headphone 2. The headphone user in the instant embodiment adjusts the volume of the sound outputted by the speaker of the headphone cable 2 through the playback apparatus 3.

The rest of the structure of the headphone cable 4 in FIG. 4 is essentially the same as the headphone cable 1 in FIG. 1, and those skilled in the art should be able to infer the exact structure design and the operation of the headphone 4 such as the actual types of the plug 19 and means of modifying the headphone cable 4 to incorporate dual plug structure from the above explanation, and further descriptions are hereby omitted.

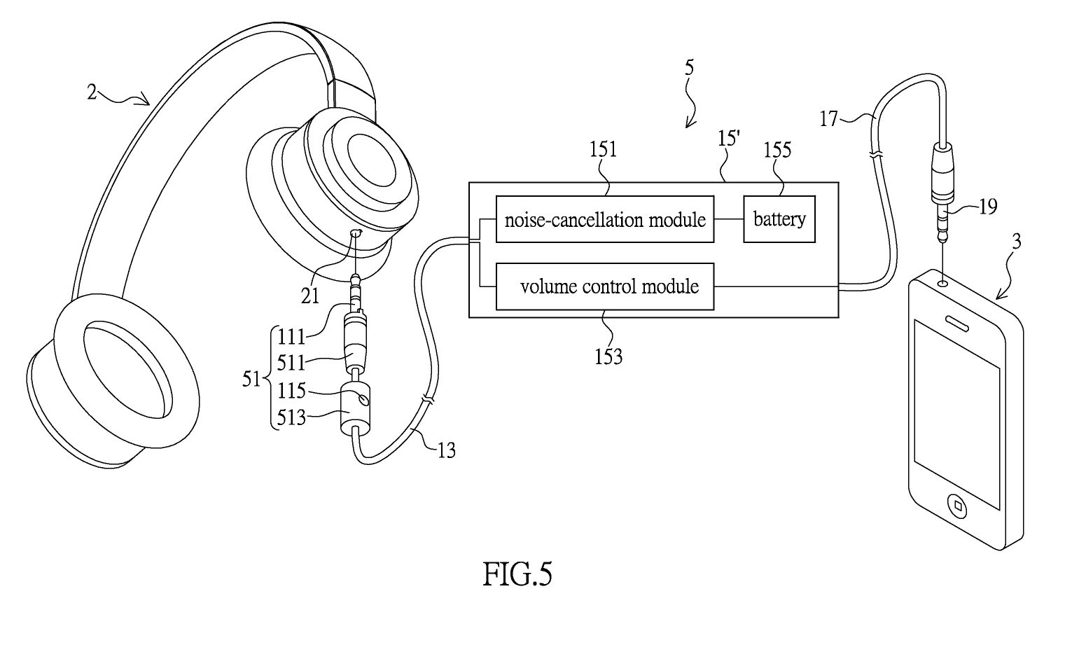

In another embodiment, the aforementioned first plug may be formed of multiple isolation portions, and the first microphone module may be disposed on one of the isolation portions according to the design or product needs. Please refer to FIG. 5, which shows a diagram illustrating another headphone cable provided in accordance to a third exemplary embodiment of the present disclosure.

The difference between the headphone cable 5 of FIG. 5 and the headphone cable 1 of FIG. 1 is in the structure of the first plug. A first plug 51 of the headphone cable 5 includes a first connector 111, isolation portions 511, 513, and a first microphone module 115. The first connector 111 is protruded on the isolation portion 511. The isolation portion 511 is connected to the isolation portion 511 through a transmission line. The isolation portion 513 is electrically connected to a headphone adapter 15′ through the first transmission line 13. The first microphone module 115 is spaced from the first connector 111 for a predetermined distance. Particularly, the predetermined distance is configured to be less than 10 cm for effectively receiving the environmental noises surround the headphone 2.

The isolation portion 511 further has a first rotational angle limiting structure while a first headphone jack 21 of the headphone 2 has a first connecting structure corresponding to the first rotational angle limiting structure. Such that when the first connector 111 plugs into the first headphone jack 21 of the headphone 2, the first rotational angle limiting structure connects the first connecting structure for limiting the rotational angle of the first microphone module 115 and causes the first microphone module 115 to face away from a speaker direction of the headphone 2.

The first microphone module 115 in the instant embodiment is disposed on the isolation portion 513. However, in other embodiment, the first microphone module 115 may be disposed on the isolation portion 511. The exact placement of the first microphone module 115 may be configured according to the degree of sensitivity required for sensing environmental noises, actual sound receiving requirement or visual design needs. The shape, size, and length of the isolation portions 511 and 513 may be configured to be the same or different according to the actual needs.

The rest of the structure of the headphone cable 5 in FIG. 5 is essentially the same as the headphone cable 1 in FIG. 1, and those skilled in the art should be able to infer the exact structural design such as the exact types of the plug 19 and means of modifying the headphone cable 5 to incorporate dual plug structure from the above explanation, and further description are hereby omitted.

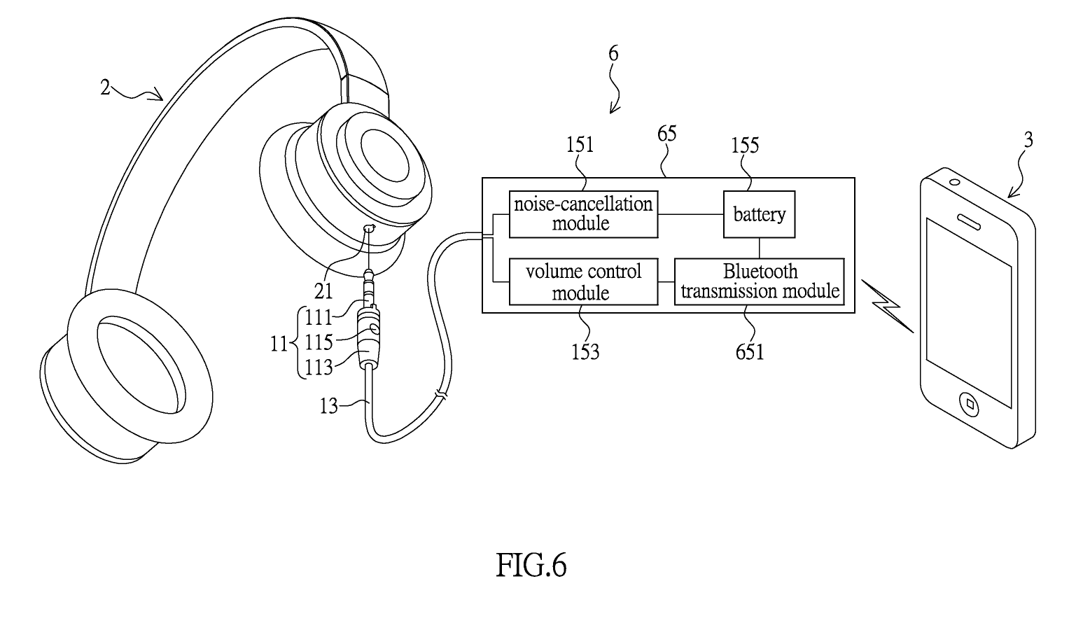

Next, please refer to FIG. 6, which shows a diagram illustrating a headphone cable provided in accordance to a fourth exemplary embodiment of the present disclosure.

The difference between the headphone cable 6 of FIG. 6 and the headphone cable 1 of FIG. 1 is in the structure of the headphone adapter. In the instant embodiment, the headphone cable has a headphone adapter 65, which can communicate with the playback apparatus 3 via Bluetooth communication to wirelessly receive the audio signals from the playback apparatus 3.

The headphone adapter 65 includes a noise-cancellation module 151, a volume control module 153, a battery 155, and a Bluetooth transmission module 651. The noise-cancellation module 151 and the volume control module 153 are electrically connected to the first transmission line 13, respectively. The noise-cancellation module 151 and the Bluetooth transmission module 651 are electrically connected to the battery 155, respectively. The battery 155 is configured for supplying the necessary operational power to the noise-cancellation module 151 and the Bluetooth transmission module 651. The Bluetooth transmission module 651 wirelessly connects to the playback apparatus 3 to receive the audio signal transmitted by the playback apparatus 3. The Bluetooth transmission module 651 operatively outputs the audio signals received to the volume control module 153 and transmits the audio signals to the headphone 2 through the volume control module 153 and the first transmission line 13. The noise-cancellation module 151 at same time outputs the noise-cancellation signals, which are generated in responsive to the environmental noised received by the first microphone module 151, to the audio signals received by the headphone 2 so as to eliminate the impact of the environmental noises.

The rest of the structure of the headphone cable 6 in FIG. 6 is essentially the same as the headphone cable 1 in FIG. 1, and those skilled in the art should be able to infer the exact structure design and the operation of the headphone 6 from the above explanation and further descriptions are hereby omitted.

In summary, the headphone cable disclosed can through respectively disposing the microphone component for sensing noises and the noise-cancellation circuit on a connector of the headphone cable being used for plugging into the headphone and on the headphone cable, and utilizing the noise feedback technique, actively remove the noises received by the headphone so as to enhance the sound quality of the headphone. The structure of the headphone cable and the plug thereof disclosed further can be flexibly designed according to the exact type and the exact structure of the headphone and the playback apparatus. Thereby, enhances the applicability of the headphone cable. Accordingly, the present disclosure provides the headphone cable and the plug thereof which can simplify the headphone circuitry design and associated cost while attaining the objective of removing the impact of environmental noise on the sound performance of headphone.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A headphone cable, adapted for connecting a headphone to a playback apparatus, the headphone cable comprising:
a first plug having a first isolation portion with a first connector protruded thereon, wherein the first connector is adapted for plugging into a first headphone jack of the headphone;
a first microphone module, disposed on the first isolation portion;
a first transmission line having one end thereof electrically connected to the first plug;
a noise-cancellation module, electrically connected to the other end of the first transmission line; and
a second transmission line, electrically connecting to the noise-cancellation module and the playback apparatus;
wherein the noise-cancellation module correspondingly generates a noise-cancellation signal to be combined with an audio signal being outputted to the headphone in responsive to an environmental noise received through the first microphone module.

2. The headphone cable according to claim 1, further comprising:
a second plug having a second isolation portion with a second connector protruded thereon;
a second microphone module, disposed on the second isolation portion, and configured for receiving the environmental noise; and
a third transmission line, electrically connected the second plug to the noise-cancellation module.

3. The headphone cable according to claim 1, wherein the first isolation portion has a first rotational angle limiting structure while the first headphone jack has a first connecting structure corresponding to the first rotational angle limiting structure, wherein when the first connector plugs into the first headphone jack, the first rotational angle limiting structure connects the first connecting structure for limiting the rotational angle of the first microphone module and causes the first microphone module to face away from a speaker direction of the headphone.

4. The headphone cable according to claim 2, wherein the second isolation portion has a second rotational angle limiting structure while a second headphone jack of the headphone has a second connecting structure corresponding to the second rotational angle limiting structure, wherein when the second connector plugs into the second headphone jack, the second rotational angle limiting structure connects the second connecting structure for limiting the rotational angle of the second microphone module and causes the second microphone module to face away from a speaker direction of the headphone.

5. The headphone cable according to claim 1, further comprising:
a volume control module, electrically connected between the first transmission line and the second transmission line, wherein the volume control module and the noise-cancellation module are integrated in a headphone adapter; and
a battery, electrically connected to the noise-cancellation module, and configured for powering the noise-cancellation module.

6. The headphone cable according to claim 1, wherein the first transmission line comprises:
at least an audio wire, electrically connected between the noise-cancellation module and the first plug, and configured for transmitting the audio signal; and
at least a microphone wire, electrically connected between the first microphone module and the noise-cancellation module, and configured for transmitting a noise signal outputted by the first microphone module.

7. The headphone cable according to claim 1, further comprising:
a third plug, connected to one end of the second transmission line, and configured for plugging into an audio jack of the playback apparatus.

8. The headphone cable according to claim 1, wherein the distance between the first microphone module and the first connector is less than or equal to 10 centimeter (cm).

9. A plug of headphone, adapted for connecting to a headphone, the plug comprising:
an isolation portion;
a connector, protruded on the isolation portion, wherein the connector is adapted to plug into a headphone jack of the headphone; and
a microphone module, disposed on the isolation portion.

10. The plug of headphone according to claim 9, wherein the isolation portion has a rotational angle limiting structure while the headphone jack has a connecting structure corresponding to the rotational angle limiting structure, wherein when the connector plugs into the headphone jack, the rotational angle limiting structure connects the connecting structure for limiting the rotational angle of the microphone module and causes the microphone structure to face away from a speaker direction of the headphone.

11. The plug of headphone according to claim 9, further comprising:
a noise-cancellation module, electrically connected to the other end of the first transmission line, wherein the noise-cancellation module is disposed in the isolation portion and operatively generates a noise-cancellation signal in responsive to an environmental noise received through the microphone module; and
a battery, electrically connected to the noise-cancellation module, for powering the noise-cancellation module, wherein the battery is disposed in the isolation portion.

12. A headphone cable, adapted for connecting a headphone to a playback apparatus, the headphone cable comprising:
a first plug having a first isolation portion with a first connector protruded thereon, wherein the first connector is adapted for plugging into a first headphone jack of the headphone;
a first microphone module, disposed on the first isolation portion, and configured for operatively generating a noise signal upon receiving an environmental noise;
a first transmission line having one end thereof electrically connected to the first plug; and
a headphone adapter having a Bluetooth transmission module and a noise-cancellation module, wherein the Bluetooth transmission module wirelessly connects to the playback apparatus, and the noise-cancellation module electrically connects to the other end of the transmission line;
wherein the noise-cancellation module correspondingly generates a noise-cancellation signal to be combined with an audio signal being transmitted to the headphone in responsive to an environmental noise received through the first microphone module.

13. The headphone cable according to claim 12, further comprising:
a second plug having a second isolation portion with a second connector protruded thereon;
a second microphone module, disposed on the second isolation portion, and configured for receiving the environmental noise; and
a third transmission line, electrically connected the second plug to the noise-cancellation module.

14. The headphone cable according to claim 12, wherein the first isolation portion has a first rotational angle limiting structure while the first headphone jack has a first connecting structure corresponding to the first rotational angle limiting structure, wherein when the first connector plugs into the first headphone jack, the first rotational angle limiting structure connects the first connecting structure for limiting the rotational angle of the first microphone module and causes the first microphone structure to face away from a speaker direction of the headphone; the second isolation portion has a second rotational angle limiting structure while a second headphone jack of the headphone has a second connecting structure corresponding to the second rotational angle limiting structure, wherein when the second connector plugs into the second headphone jack, the second rotational angle limiting structure connects the second connecting structure for limiting the rotational angle of the second microphone module and causes the second microphone structure to face away from the speaker direction of the headphone.

15. The headphone cable according to claim 12, further comprising:
a volume control module, electrically connected between the first transmission line and the second transmission line, wherein the volume control module and the noise-cancellation module are integrated in the headphone adapter;
a battery, electrically connected to the noise-cancellation module, and configured for powering the noise-cancellation module
at least an audio wire, electrically connected between the noise-cancellation module and the first plug, and configured for transmitting the audio signal; and
at least a microphone wire, electrically connected between the first microphone module and the noise-cancellation module, and configured for transmitting the noise signal outputted by the first microphone module.
